(19) United States
(12) Patent Application Publication
(10) Pub. No.: US 2009/0012779 A1
(43) Pub. Date: Jan. 8, 2009

(54) Sound source separation apparatus and sound source separation method

(76) Inventors: Yohei Ikeda, Hyogo (JP); Takashi Hiekata, Hyogo (JP); Takashi Morita, Hyogo (JP); Hiroshi Saruwatari, Nara (JP); Yoshimitsu Mori, Nara (JP)

Correspondence Address: REED SMITH LLP, Suite 1400, 3110 Fairview Park Drive, Falls Church, VA, 22042, US

(21) Appl. No.: 12/073,336

(22) Filed: Mar. 4, 2008

(30) Foreign Application Priority Data
Mar. 5, 2007 (JP) P2007-053791

(51) Int. Cl. G10L 21/00

(52) U.S. Cl. 704/205

(57) ABSTRACT

A sound source separation apparatus includes: an SIMO-ICA process unit, separating and generating an SIMO signal by the BSS method based on the ICA method; a sound source direction estimation unit, estimating a sound source direction based on a separating matrix, computed by a learning calculation of the BSS method based on the ICA method; a beamformer process unit, performing, on each SIMO signal, a beamformer process of enhancing, according to each frequency bin, a sound component from each sound source direction; an intermediate process unit, performing an intermediate process that includes performing a selection process, etc., according to each frequency bin on signals other than a specific signal among the beamformer processed sound signals; and an untargeted signal component elimination unit, eliminating noise signal components by comparing for one signal in the specific SIMO signal, volumes of the specific beam former processed sound signal and the intermediate processed signal according to each frequency bin.

### BACKGROUND OF THE INVENTION

The present invention relates to a sound source separation apparatus and a sound source separation method for identifying (separating) at least one individual sound signal from a plurality of mixed sound signals, which, in a state where a plurality of sound sources and a plurality of sound input means are present in a predetermined acoustic space, are respectively inputted through the plurality of sound input means and in which are superimposed the respective individual sound signals from the plurality of sound sources.

When a plurality of sound sources and a plurality of microphones (sound input means) are present in a predetermined acoustic space, sound signals (referred to herein after as “mixed sound signals”), in which are superimposed respective individual sound signals (referred to herein after as the “sound source signals”) from the plurality of sound sources, are respectively acquired through the plurality of microphones. A method for performing a sound source separation process of identifying (separating) the respective sound source signals based on just the plurality of mixed sound signals that are thus acquired (input) is called the blind source separation method (referred to herein after as the “BSS” method).

Further, as one type of BSS method, there is a BSS method based on the independent component analysis method (referred to herein after as the “ICA” method). With the BSS method based on the ICA method (ICA-BSS), the mutual statistical independence of the sound source signals in the plurality of mixed sound signals (time series sound signals) inputted through the plurality of microphones is used to optimize a predetermined inverse mixing matrix and a filter process using the optimized inverse mixing matrix is applied to the plurality of input mixed sound signals to perform identification (sound source separation) of the sound source signals.

Meanwhile as a sound source separation process, a sound source separation process by a binary masking process (an example of a binaural signal process) is also known. The binary masking process is a sound source separation process in which respective volume levels, of each of plurally sectioned frequency components (frequency bins), are mutually compared among mixed sound signals in putted through a plurality of directional stereo microphones to eliminate, from each mixed sound signal, signal components other than those of a sound signal from a primary sound source, and is a process that can be realized with a comparatively low computational load.

Also in the BSS method based on the ICA method, a separating matrix is obtained by learning calculation, and various arts of using the separating matrix to estimate a direction of arrival (DOA), in which a sound source is present, are known.

However, there is a problem that, when the BSS based on the ICA method, which makes note of the independency of the sound source signals (individual sound signals), is used in an actual environment, sound signal components from sound sources other than a specific sound source become mixed in a separated signal due to effects of sound signal transmission characteristics, etc.

Also, with the sound source separation process by the binaural signal process, because the sound source separation process is performed by comparing the volume levels of each of the plurally sectioned frequency components (frequency bins), the sound source separation process performance is poor when there is a bias in the positions of the sound sources with respect to the plurality of microphones. For example, when the plurality of sound sources are concentrated in a sound collection region of a certain directional stereo microphone, the sound source separation process cannot be correctly performed.

### SUMMARY

It is therefore an object of the invention to provide a sound source separation apparatus and a sound source separation method that can provide a high sound source separation performance even under an environment where a bias in positions of sound sources with respect to a plurality of microphones can occur.

In order to achieve the object, according to the invention, there is provided a sound source separation apparatus, comprising:
a plurality of sound input means, into which a plurality of mixed sound signals in which sound source signals from a plurality of sound sources are superimposed are inputted;
an SIMO-ICA process means, separating and generating SIMO signals each of which corresponds to at least one of the sound source signals from the plurality of mixed sound signals by a sound source separation process of a blind source separation method based on an independent component analysis method;
a sound source direction estimation means, estimating sound source directions which are directions in which the sound sources are present, respectively, based on a separating matrix calculated by a learning calculation executed in the sound source separation process of the blind source separation method based on the independent component analysis method in the SIMO-ICA process means;
a beamformer process means,
   applying, to each of the SIMO signals separated and generated in the SIMO-ICA process means, a beam former process of enhancing, according to each of plurally sectioned frequency components, a sound component from each of the sound source directions estimated by the sound source estimation means, and
   outputting beamformer processed sound signals;
an intermediate process execution means,
   performing a predetermined intermediate process including a selection process or a synthesis process, according to each of the plurally sectioned frequency components, on the beamformer processed sound signals other than a specific beamformer processed sound signal with which a sound component from a specific sound source direction which is one of the sound source directions is enhanced for a specific SIMO signal which is one of the SIMO signals, and
   outputting an intermediate processed signal obtained thereby; and
an untargeted signal component elimination means,
   performing, on one signal in the specific SIMO signal, a process of comparing volumes of the specific beamformer processed sound signal and the intermediate processed signal according to each of the plurally sectioned frequency components and, when a comparison result meets a predetermined condition, of eliminating a signal of the corresponding frequency component, and
   generating a signal obtained thereby as a separated signal corresponding to one of the sound source signals.

### BRIEF DESCRIPTION OF THE DRAWINGS

FIG. 1 is a block diagram of a general arrangement of a sound source separation apparatus according to a first embodiment of the present invention.

FIG. 2 is a block diagram of a general arrangement of a sound source separation apparatus according to a second embodiment of the present invention.

FIG. 3 is a block diagram of a general arrangement of a related sound source separation apparatus that performs a BSS method based on a TDICA method.

FIG. 4 is a block diagram of a general arrangement of a related sound source separation apparatus that performs a sound source separation process based on a TD-SIMO-ICA method.

FIG. 5 is a block diagram of a general arrangement of a related sound source separation apparatus that performs a sound source separation process based on an FDICA method.

FIG. 6 is a block diagram of a general arrangement of a related sound source separation apparatus that performs a sound source separation process based on an FD-SIMO-ICA method.

FIG. 7 is a block diagram of a general arrangement of a related sound source separation apparatus that performs a sound source separation process based on an FDICA-PB method.

FIGS. 8A and 8B show schematic diagrams of first examples (cases where there is no overlapping of frequency components among the respective sound source signals) of signal level distributions according to the frequency component of signals before and after applying a binary masking process to signals resulting from applying a beamformer process on SIMO signals.

FIGS. 9A and 9B show schematic diagrams of second examples (cases where there is overlapping of frequency components among the respective sound source signals) of signal level distributions according to the frequency component of signals before and after applying a binary masking process to signals resulting from applying a beamformer process on SIMO signals.

FIGS. 10A and 10B show schematic diagrams of third examples (cases where levels of targeted sound source signals are comparatively low) of signal level distributions according to the frequency component of signals before and after applying a binary masking process to signals resulting from applying a beamformer process on SIMO signals.

FIG. 11 is a schematic diagram of a positional relationship of microphones and sound sources.

FIG. 12 is a conceptual diagram of a delay and sum beamformer process.

FIG. 13 is a diagram of experimental conditions of sound source separation process evaluation using the sound source separation apparatus.

FIG. 14 is a graph of sound source separation process performances of a sound source separation process performed by a related sound source separation apparatus and a sound source separation apparatus according to the present invention under predetermined experimental conditions.

### DETAILED DESCRIPTION OF PREFERRED EMBODIMENTS

Before describing embodiments of the present invention, sound source separation apparatuses that perform BSS method based on various ICA method (BSS method based on the ICA method) shall be described.

Furthermore, each of the sound source separation processes or apparatuses that perform the processes relates to a sound source separation process or an apparatus that performs the process for generating a separated signal by separating (extraction) at least one individual sound signal (referred to herein after as the “sound source signal”) from a plurality of mixed sound signals, which, in a state where a plurality of sound sources and a plurality of microphones (sound input means) are present in a predetermined acoustic space, are respectively inputted through the plurality of microphones and in which are superimposed the respective sound source signals from the plurality of sound sources.

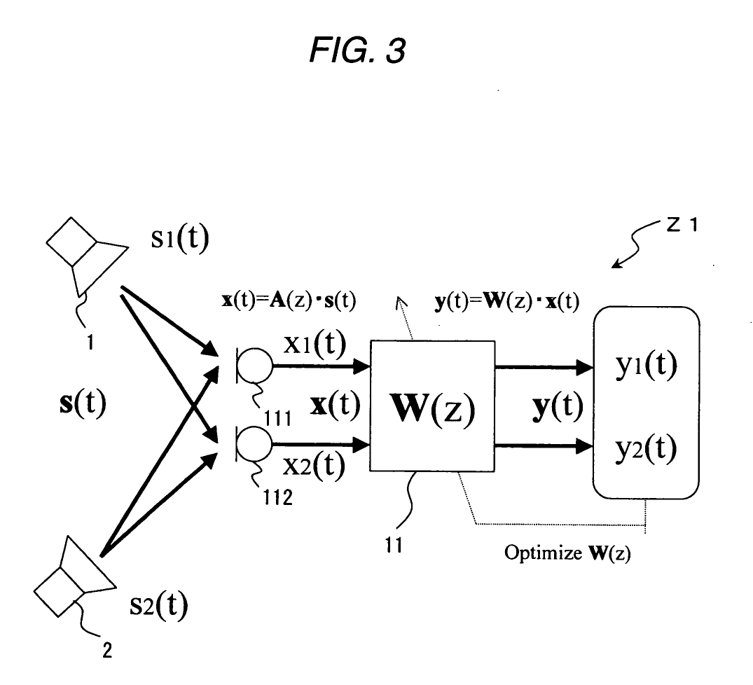

FIG. 3 is a block diagram of a general arrangement of a related sound source separation apparatus Z1 that performs a sound source separation process of the BSS method based on a time-domain independent component analysis method (referred to herein after as the “TDICAe method”), which is one type of ICA method.

In the sound source separation apparatus Z1, a separation filter process unit 11 performs a sound source separation process by applying a filter process by a separating matrix W(z) on mixed sound signals x1(t) and x2(t) of two channels (number of microphones) into which sound source signals S1(t) and S2(t) (respective sound signals of sound sources) from two sound sources 1 and 2 are inputted by two microphones (sound input means) 111 and 112. Although an example of performing the sound source separation process based on the mixed sound signals x1(t) and x2(t) of two channels (number of microphones) into which the sound source signals S1(t) and S2(t) (individual sound signals) from the two sound sources 1 and 2 are inputted by the two microphones (sound input means) 111 and 112 is shown in FIG. 3, the same applies when there are two channels or more. In the case of sound source separation of the BSS method based on the ICA method, it suffices that: (the number n of channels of the inputted mixed sound signal (that is, the number of microphones))≧ (the number m of sound sources).

In each of the mixed sound signals x1(t) and x2(t), respectively collected by the plurality of microphones 111 and 112, the sound signals from the plurality of sound sources are superimposed. In the following, the respective mixed sound signals x1(t) and x2(t) shall be expressed collectively as x(t). The mixed sound signal x(t) is expressed as a time-space convolution signal of a sound source signal S(t) and is expressed by a following formula (1):

### [Mathematical Formula 1]

x(t)=A(z)·s(t) (1)

Here, A(z) is a spatial matrix of the sound signals inputted from the sound sources into the microphones.

The theory of the sound source separation process by TDICA is based on the concept that, by making use of statistical independence of the respective sound sources of the sound source signal S(t), S(t) can be estimated if x(t) is known and the sound sources can thus be separated.

Here, if W(z) is the separating matrix used in the sound source separation process, a separated signal (that is, an identified signal) y(t) is expressed by the following formula (2):

### [Mathematical Formula 2]

y(t)=W(z)·x(t) (2)

Here, W(z) is determined by successive calculation from the output y(t). Just the same number of separated signals as the number of channels is obtained.

Furthermore, in a sound source synthesis process, a matrix corresponding to an inverse operation process is formed based on information concerning W(z) and the inverse operation using this matrix is performed.

By performing such a sound source separation process by the BSS method based on the ICA method, for example, a sound source signal of a singing voice of a person and a sound source signal of a guitar or other instrument is separated (identified) from mixed sound signals of a plurality of channels in which the sound of the singing voice and the sound of the instrument are mixed.

Here, the formula (2) can be rewritten as follows to a formula (3):

$$\begin{matrix}[ Mathematical Formula 3 ] & \\ = {\sum }_{n = 0}^{D - 1} w ( n ) x ( t - n ) & ( 3 )\end{matrix}$$

In the above, D denotes the number of taps of a separating filter W(n).

The separating filter (separating matrix) W(n) in the formula (3) is successively calculated by a following formula (4). That is, by successively applying the output y(t) of a previous update (j), W(n) of a present update (j+1) is determined.

$$\begin{matrix}[ Mathematical Formula 4 ] & \\ {w}^{[ j + 1 ]} ( n ) = {w}^{[ j ]} ( n ) - α {\sum }_{d = 0}^{D - 1} \{ off \text{-} diag {〈 ϕ ( {y}^{[ j ]} ( t ) ) {{y}^{[ j ]} ( t - n + d )}^{T} 〉}_{i} \} \cdot {w}^{[ j ]} ( d ) & ( 4 )\end{matrix}$$

In the above, a denotes an update coefficient, [j] denotes the number of updates, and < . . . >ₜ denotes a time average. off-diag X denotes an operation process of replacing all diagonal elements of a matrix X by zero.

φ( . . . ) denotes a suitable non-linear vector function having a sigmoid function, etc., as elements.

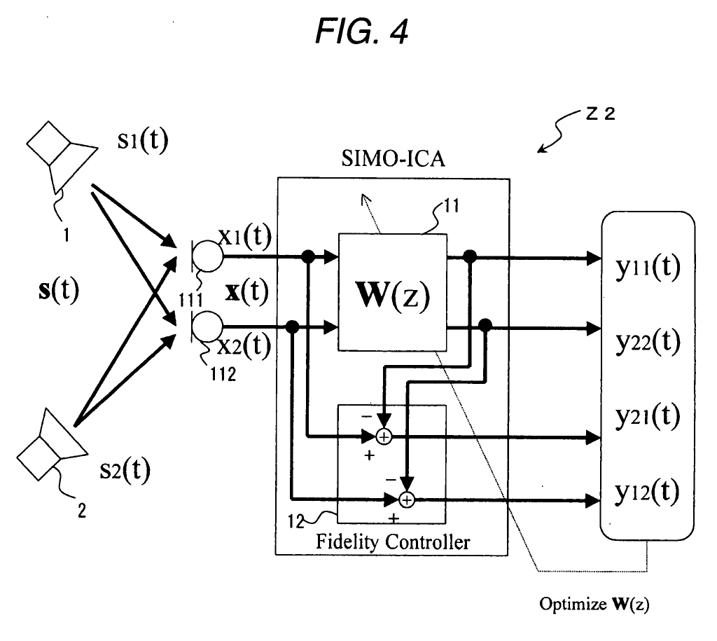

A block diagram of FIG. 4 shall now be used to describe an arrangement of a related sound source separation apparatus Z2 that performs a sound source separation process based on a time-domain single-input multiple-output ICA method (referred to herein after as the “TD-SIMO-ICA method”), which is one type of TDICA method. Although an example of performing a sound source separation process based on the mixed sound signals x1(t) and x2(t) of two channels (number of microphones) is shown in FIG. 4, the same applies when there are three channels or more.

A characteristic of the sound source separation process by the TD-SIMO-ICA method is that, by means of a fidelity controller 12, shown in FIG. 4, separated signals (identified signals), separated (identified) by the sound source separation process (sound source separation process based on the TD-SIMO-ICA method), are subtracted from respective mixed sound signals xi(t), which are microphone input signals, and statistical independences of the signal components obtained by the subtraction are evaluated to update (perform successive calculation of) the separating filter W(Z). Here, the separated signals (identified signals) to be subtracted from the respectivemixed sound signals xi(t) are all of the remaining separated signals other than a single separated signal (separated signal obtained by the sound source separation process based on the corresponding mixed sound signal) that differs for each mixed sound signal xi(t). Two separated signals (identified signals) are thereby obtained for each channel (microphone), and two separated signals are obtained for each sound source signal Si(t). In the example of FIG. 4, separated signals y11(t) and y12(t) and separated signals y22(t) and y21(t) are respectively separated signals (identified signals) corresponding to the same sound source signal. In the subscript (numerals) of the separated signal y, the first numeral denotes an identification number of a sound source and the second numeral denotes an identification number of a microphone (that is, a channel) (the same applies herein after).

In such a case where at least one sound source signal (individual sound signal) is separated (identified) from a plurality of mixed sound signals, which, in a state where a plurality of sound sources and a plurality of sound input means (microphones) are present in a certain acoustic space, are respectively inputted through the plurality of sound input means and in which are superimposed the respective individual sound signals from the sound sources, a set of a plurality of separated signals (identified signals) obtained for each sound source signal is referred to as an SIMO (single-input multiple-output) signal. With the example of FIG. 4, each combination of separated signals that correspond to the same sound source signal and are separated according to the respective microphones, that is, each of the combination of the separated signals y11(t) and y12(t) and the combination of the separated signals y22(t) and y21(t) is an SIMO signal.

Here, an update formula for W(n), by which the separating filter (separating matrix) W(Z) is re-expressed, is expressed by a following formula (5):

$$\begin{matrix}[ Mathematical Formula 5 ] & \\ {w}_{ICA l}^{[ j + 1 ]} ( n ) = {w}_{ICA l}^{[ j ]} ( n ) - α {\sum }_{d = 0}^{D - 1} \{ off \text{-} diag 〈 ϕ ( {y}_{ICAl}^{[ j ]} ( t ) ) {{y}_{ICA l}^{[ j ]} ( t - n + d )}^{τ} 〉 , \} \cdot {w}_{ICA l}^{[ j ]} ( d ) + α {\sum }_{d = 0}^{D - 1} \{ off \text{-} diag 〈 ϕ ( x ( t - \frac{D}{2} ) - {\sum }_{l = 1}^{L - 1} {y}_{ICA l}^{[ j ]} ( t ) ) \cdot {( x ( t - \frac{D}{2} - n + d ) - {\sum }_{l = 1}^{L - 1} {y}_{ICA l}^{[ j ]} ( t - n + d ) )}^{τ} 〉 , \} \cdot ( I δ ( d - \frac{D}{2} ) - {\sum }_{l = 1}^{L - 1} {w}_{ICA l}^{[ j ]} ( d ) ) & ( 5 )\end{matrix}$$

In the above, α denotes an update coefficient, [j] denotes the number of updates, and < . . . >ₜ denotes a time average.

off-diag X denotes an operation process of replacing all diagonal elements of a matrix X by zero.

φ( . . . ) denotes a suitable non-linear vector function having a sigmoid function, etc., as elements.

The subscript “ICA1” of W and y indicates an 1(L) ICA component inside the SIMO-ICA portion.

With the formula (5), a third term is added to the formula (4), and by this third term, the independences of the signals generated by the fidelity controller 12 are evaluated.

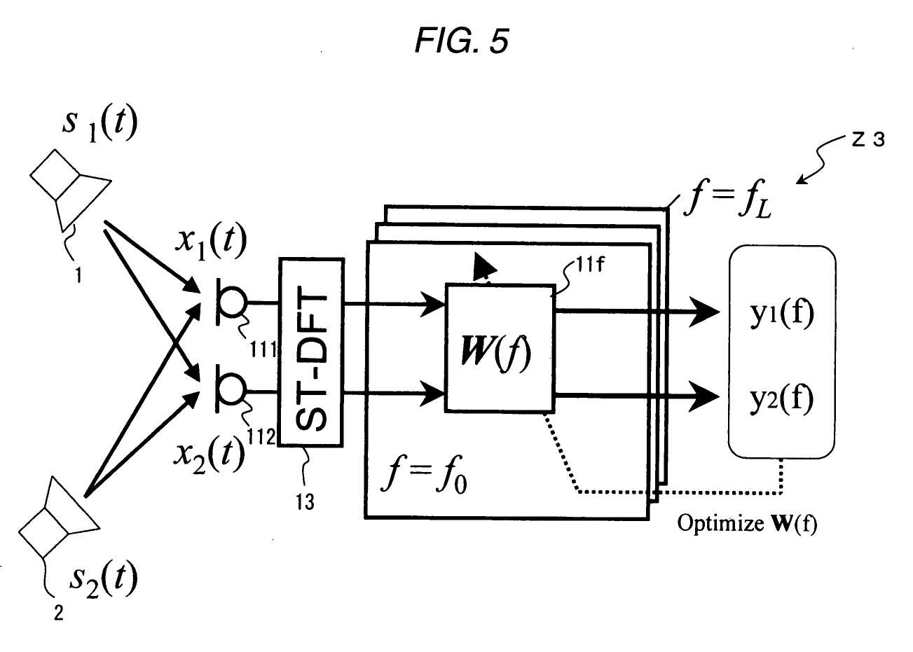

A block diagram of FIG. 5 shall now be used to describe a related sound source separation apparatus Z3 that performs a sound source separation process based on an FDICA method (frequency-domain ICA), which is one type of ICA method.

With the FDICA method, first, on the inputted mixed sound signal x(t), a short time discrete Fourier transform (referred to herein after as the “ST-DFT process”) is performed according to each frame, which is a signal sectioned according to a predetermined cycle, by an ST-DFT process unit 13 to thereby perform short time analysis of the observation signal. Then on the signals of the respective channels (signals of the respective frequency components) after the ST-DFT process, a separation filter process based on a separating matrix W(f) is applied by a separating filter process unit 11f to perform sound source separation process (identification of the sound source signals). Here, when f is a frequency bin and m is an analyzed frame number, a separated signal (identified signal) Y(f, m) can be expressed by a following formula (6):

### [Mathematical Formula 6]

Y(f,m)=W(f)·X(f,m) (6)

Here, an update formula for the separating filter W(f) can be expressed, for example, by a following formula (7):

### [Mathematical Formula 7]

W_{(ICA1)}^{[i+1]}(f)=W_{(ICA1)}^{[i]}(f)−η(f)[off−diag{ [symbol] φ(Y_{(ICA1)}^{[i]}(f,m))Y_{(ICA1)}^{[i]}(f,m)^{H} [symbol] ₘ}]W_{(ICA1)}^{[i]}(f) (7)

In the above, η(f) denotes an update coefficient, i denotes the number of updates, < . . . >ₜ denotes a time average, and H denotes an Hermite transposition.

off-diag X denotes an operation process of replacing all diagonal elements of a matrix X by zero.

φ( . . . ) denotes a suitable non-linear vector function having a sigmoid function, etc., as elements.

With the FDICA method, the sound source separation process is handled as an instantaneous mixing problem in each narrow band and the separating filter (separating matrix) W(f) can be updated comparatively readily and with stability.

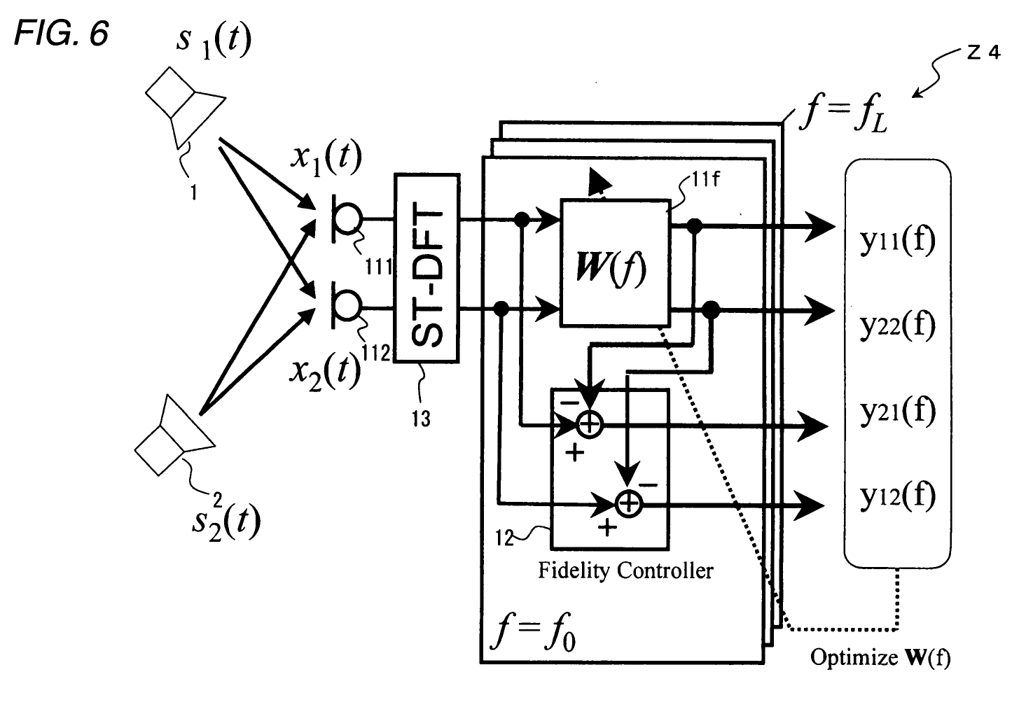

A block diagram of FIG. 6 shall now be used to describe a related sound source separation apparatus Z4 that performs a sound source separation process based on a frequency-domain SIMO independent component analysis method (referred to herein after as “FD-SIMO-ICA method”), which is a type of FDICA method.

In a manner similar to the TD-SIMO-ICA method (FIG. 4), with the FD-SIMO-ICA method, by means of the fidelity controller 12, separated signals (identified signals), separated (identified) by the sound source separation process based on the FDICA method (FIG. 5), are subtracted from respective signals, resulting from applying the ST-DFT process to the respective mixed sound signals xi(t), and statistical independences of the signal components obtained by the subtraction are evaluated to update (perform successive calculation of) a separating filter W(f).

With the sound source separating apparatus Z4 based on the FD-SIMO-ICA method, the plurality of mixed sound signals x1(t) and x2(t) in the time domain are subject to the short time discrete Fourier transform process by the ST-DFT process unit 13 and converted into a plurality of mixed sound signals x1(f) and x2(f) in the frequency domain (an example of a short time discrete Fourier transform means).

Next, by applying a separation process (filter process), based on the predetermined separating matrix W(f), by means of the separating filter process unit 11f on the converted plurality of mixed sound signals x1(f) and x2(f) in the frequency domain, the first separated signals y11(f) and y22(f), corresponding to either of the sound source signals S1(t) and S2(t), are generated according to the respective mixed sound signals (example of an FDICA sound source separation process means).

Furthermore, from each of the plurality of mixed sound signals x1(f) and x2(f) in the frequency domain, the first separated signal separated by the separating filter process unit 11f based on the corresponding sound signal (y11(f), separated based on x1(f), or y22(f), separated based on x2(f)) is subtracted by the fidelity controller 12 (example of a subtraction means) to generate second separated signals y12(f) and y21(f).

Meanwhile, by means of unillustrated separating matrix calculation unit, successive calculations are performed based on both the first separated signals y11(f) and y22(f) and the second separated signals y12(f) and y21(f) to calculate the separating matrix W(f) used in the separating filter process unit 11f (FDICA sound source separation process means) (example of a separating matrix calculation means).

Two separated signals (identified signals) are thus obtained for each channel (microphone), and two or more separated signals (SIMO signal) are obtained for each sound source signal Si(t). In the example of FIG. 6, each of the combination of the separated signals y11(f) and y12(f) and the combination of the separated signals y22(f) and y21(f) is an SIMO signal. Furthermore, because in actuality, new separated signals are generated for each frame that is newly generated according to the elapse of time, the respective separated signals y11(f), y21(f), y22(f), and y12(f) can be expressed as y11(f, t), y21(f, t), y22(f, t), and y12(f, t) by adding the factor of time t.

Here, the separating matrix calculation unit calculates, based on the first separated signals and the second separated signals, the separating filter (separating matrix) W(f) by an update formula for the separating matrix W(f), expressed by a following formula (8):

$$\begin{matrix}[ Mathematical Formula 8 ] & \\ {W}_{( ICA l )}^{[ i + 1 ]} ( f ) = {W}_{( ICA l )}^{[ i ]} ( f ) - η ( f ) [ off \text{-} diag \{ {〈 ϕ ( {Y}_{( ICA l )}^{[ i ]} ( f , m ) ) {{Y}_{( ICA l )}^{[ i ]} ( f , m )}^{H} 〉}_{m} \} ] {W}_{( ICA l )}^{[ i ]} ( f ) - off \text{-} diag \{ {〈 ϕ ( X ( f , m ) - {\sum }_{l = 1}^{L - 1} {Y}_{( ICA l )}^{[ i ]} ( f , m ) ) \\ {( X ( f , m ) - {\sum }_{l = 1}^{L - 1} {Y}_{( ICAl )}^{[ i ]} ( f , m ) )}^{H} 〉}_{m} \} ( I - {\sum }_{l = 1}^{L - 1} {W}_{( ICAl )}^{[ i ]} ( f ) ) ] & ( 8 )\end{matrix}$$

In the above, η(f) denotes an update coefficient, i denotes the number of updates, < . . . >ₜ denotes a time average, and H denotes an Hermite transposition.

off-diag X denotes an operation process of replacing all diagonal elements of a matrix X by zero.

φ( . . . ) denotes a suitable non-linear vector function having a sigmoid function, etc., as elements.

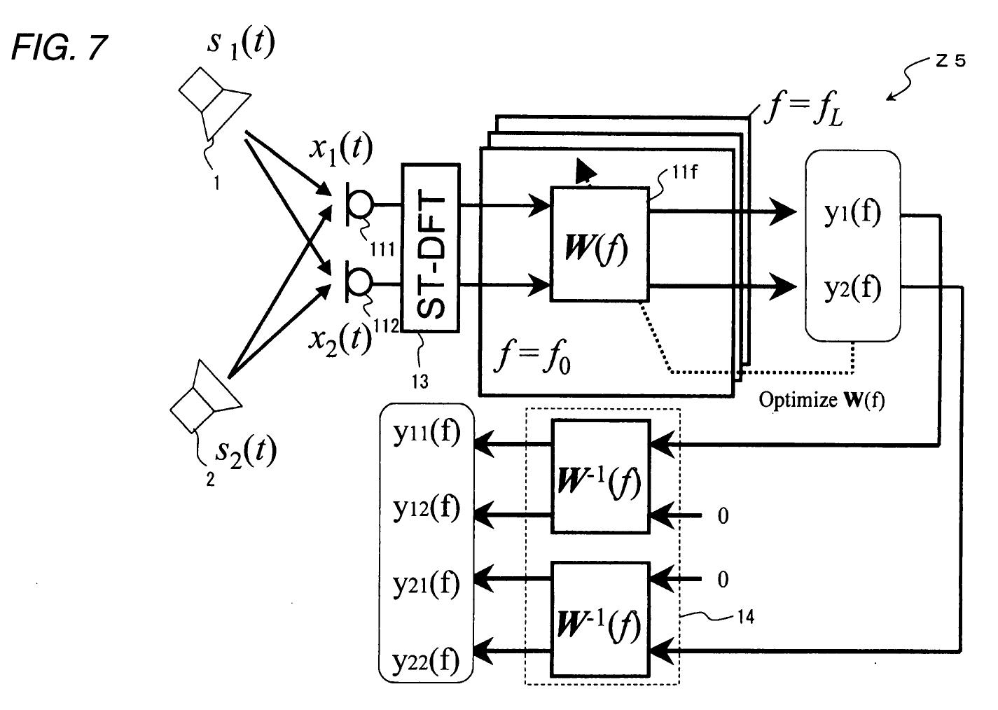

A block diagram of FIG. 7 shall now be used to describe a related sound source separation apparatus Z5 that performs a sound source separation process based on a frequency-domain ICA and the projection back method (herein after referred to as the “FDICA-PB method”), which is a type of FDICA method.

With the FDICA-PB method, an inverse matrix W⁻¹(f) of the separating matrix W(f) is applied by means of an inverse matrix computation unit 14 to respective separated signals (identified signals) yi(f), obtained by the sound source separation process based on the FDICA method (FIG. 5) described from respective mixed sound signals xi(t), to obtain final separated signals (identified signals of the sound source signals). Here, of the signals subject to processing by the inverse matrix W⁻¹(f), the remaining signal components other than the respective separated signals yi (f) are set as 0 (zero) inputs.

SIMO signals, which are the separated signals (identified signals) corresponding to the respective sound source signals Si(t), are thereby obtained for the number of channels (in plurality). In FIG. 7, the separated signals y11(f) and y12(f) and the separated signals y22(f) and y21(f) are respectively the separated signals corresponding to the same sound source signal, and each of the combination of the separated signals y11(f) and y12(f) and the combination of the separated signals y22(f) and y21(f), which is the signal after the process using the respective inverse matrices W⁻¹(f), is an SIMO signal. Because in actuality, new separated signals are generated for each frame that is newly generated according to the elapse of time, the respective separated signals y11(f), y12(f), y22(f), and y21(f) can be expressed as y11(f, t), y12(f, t), y22(f, t), and y21(f, t) by adding the factor of time t.

### First Embodiment

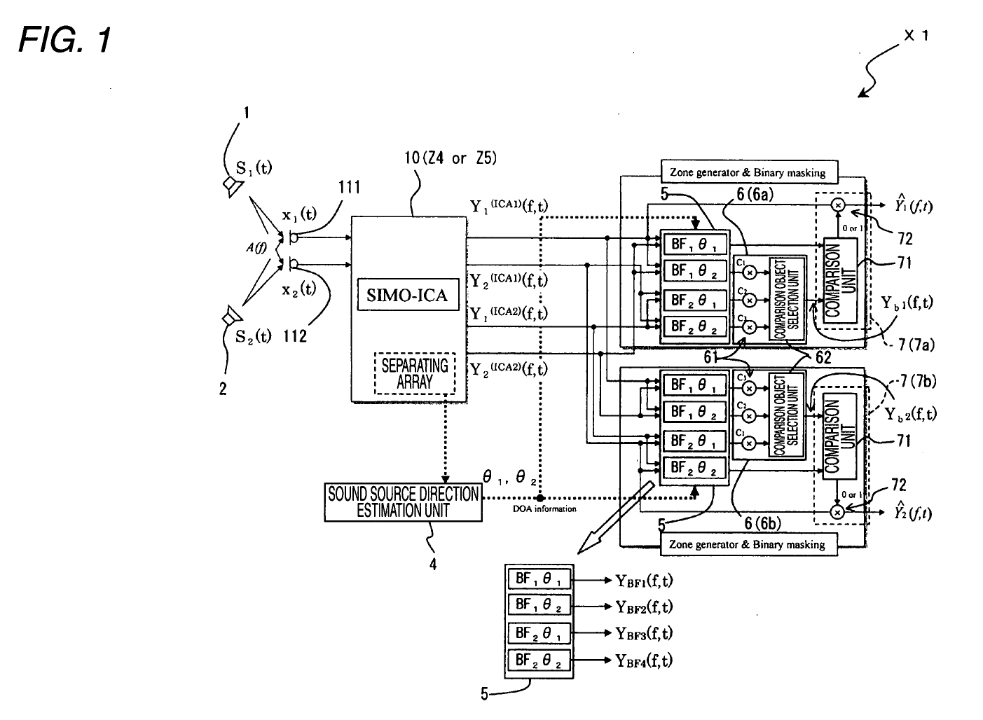

### See FIG. 1

A sound source separation apparatus X1 according to the first embodiment of the present invention shall now be described using a block diagram shown in FIG. 1.

The sound source separation apparatus X1 generates and outputs a separated signal by separating (extraction) at least one sound source signal (individual sound signal) from a plurality of mixed sound signals Xi(t), which, in a state where a plurality of sound sources 1 and 2 and a plurality of microphones 111 and 112 are present in a certain acoustic space, are respectively inputted through the plurality of microphones 111 and 112 and in which the respective sound source signals (individual sound signals) from the plurality of sound sources 1 and 2 are superimposed. Separated signals Y1^{(ICA1)}(f, t), Y2^{(ICA1)}(f, t), Y1^{(ICA2)}(f, t), and Y2^{(ICA2)}(f, t) in FIG. 1 respectively correspond to the separated signal y11(f), y22(f), y21(f), and y12(f) in FIGS. 6 and 7. Here, the plurality of microphones 111 and 112 may be directional microphones or non-directional microphones.

The sound source separation apparatus X1 includes respective components of an SIMO-ICA process unit 10, a sound source direction estimation unit 4, a beamformer process unit 5, an intermediate process unit 6, and an untargeted signal component elimination unit 7.

The components 10, 4, 5, 6, and 7 may be arranged respectively from DSPs (digital signal processors) or CPUs and peripheral devices (ROM, RAM, etc.) and programs executed by the DSPs or CPUs, or arranged as an arrangement, in which a computer, having a single CPU and peripheral devices, executes program modules corresponding to the processes performed by the respective components 10, 4, 5, 6, and 7. Provision as a sound source separation process program that makes a predetermined computer execute the processes of the respective components 10, 4, 5, 6, and 7 can also be considered.

The SIMO-ICA process unit 10 is a unit that executes a process where of separating and generating SIMO signals “Y1^{(ICA1)} and Y2^{(ICA2)}” and “Y2^{(ICA1)} and Y1^{(ICA2)}” (a plurality of separated signals corresponding to a single sound source signal) by separating (identifying) at least one sound source signal Si(t) from a plurality of mixed sound signals Xi(t) by the blind source separation method (BSS) method based on the independent component analysis method (ICA) method (an example of a computer executing the SIMO-ICA process step).

As the SIMO-ICA process unit 10 in the first embodiment, employment of the sound source separation apparatus Z4, shown in FIG. 6 and performing the sound source separation process based on the FD-SIMO-ICA method of performing the sound source separation process based on the FD-SIMO-ICA method, or the sound source separation apparatus Z5, shown in FIG. 7 and performing the sound source separation process based on the FDICA-PB method, can be considered.

The sound source direction estimation unit 4 is a unit that executes a step of estimating sound source directions θ1 and θ2, which are directions in which the sound sources 1 and 2 are present respectively, based on a separating matrix W calculated by a learning calculation executed in the BSS method based on the ICA method at the SIMO-ICA process unit 10 (an example of the computer that executes the sound source direction estimation process).

The sound source direction estimation unit 4 acquires the separating matrix W calculated by the learning calculation of the separating matrix W executed in the BSS method based on the ICA method at the SIMO-ICA process unit 10 and performs a DOA estimation calculation of estimating, based on the separating matrix W, the respective directions (referred to as the “sound source directions θ1 and θ2”) of presence of the plurality of sound sources 1 and 2 present in the acoustic space.

Here, the sound source directions θ1 and θ2 are relative angles with respect to a direction Ry, orthogonal to a direction Rx, of alignment of the plurality of microphones along a straight line, a tan intermediate position O of the microphones (a central position of a range of alignment of the plurality of microphones), as shown in FIG. 11. In FIG. 11, coordinates of the respective K microphones in the Rx direction are denoted by d₁ to d_{K}.

The sound source direction estimation unit 4 executes the DOA estimation process to estimate (compute) the sound source directions θ1 and θ2. More specifically, the sound source directions θ1 and θ2 (DOA) are estimated by multiplying the separating matrix W by a steering vector.

The DOA estimation process (referred to herein after as the “DOA estimation process based on the blind angle characteristics”) shall now be described.

In the sound source separation process by the ICA method, a matrix (separating matrix) that expresses a spatial blind angle filter is computed by learning computation and sounds from certain directions are eliminated by a filter process using the separating matrix.

In the DOA estimation process based on the blind angle characteristics, spatial dead angles expressed by the separating matrix are calculated for each frequency bin and the sound source directions (angles) are estimated by determining the average values of the spatial dead angles according to the respective frequency bins.

For example, in a sound source separation apparatus that collects the sounds of two sound sources by two microphones, the following calculation is executed in the DOA estimation process based on the blind angle characteristics. In the following description, a subscript k denotes an identification number of a microphone (k=1, 2), a subscript I denotes an identification number of a sound source (I=1, 2), f denotes a frequency bin, a subscript m of f denotes an identification number of a frequency bin (m=1, 2), Wlk(f) denotes a separating matrix obtained by learning calculation in the BSS method based on the FDICA method, c denotes speed of sound, dₖ (d₁ or d₂) denotes a distance to each microphone from an intermediate position of the two microphones (half of a mutual distance between the microphones, in other words, d₁=d₂), and θ1 and θ2 denote the respective sound source directions (DOAs) of the two sound sources.

First, by a following formula (9), a sound source angle information F1(f, θ), for each of cases of l=1 and l=2, are calculated according to the respective frequency bins of the separating filter.

$$\begin{matrix}[ Mathematical Formula 9 ] & \\ {F}_{l} ( f , θ ) = {\sum }_{k = 1}^{K} {W}_{lk}^{( ICA )} ( f ) exp [ j2π {fd}_{k} sin θ / c ] & ( 9 )\end{matrix}$$

Furthermore, by formulae (10) and (11) shown below, the DOAs (angles) θ1(fm) and θ2(fm) are determined for the respective frequency bins.

$$\begin{matrix}[ Mathematical Formula 10 ] & \\ {θ}_{1} ( {f}_{m} ) = min [ arg {min}_{θ} \vert {F}_{1} ( {f}_{m} , θ ) \vert , arg {min}_{θ} \vert {F}_{2} ( {f}_{m} , θ ) \vert ] & ( 10 ) \\ [ Mathematical Formula 11 ] & \\ {θ}_{2} ( {f}_{m} ) = max [ arg {min}_{θ} \vert {F}_{1} ( {f}_{m} , θ ) \vert , arg {min}_{θ} \vert {F}_{2} ( {f}_{m} , θ ) \vert ] & ( 11 )\end{matrix}$$

Regarding the θ1(fm)'s calculated for the respective frequency bins, an average value is calculated for the range of all frequency bins, and the average value is deemed to be the direction θ1 of one of the sound sources. Likewise, from the θ2(fm)'s calculated for the respective frequency bins, an average value is calculated for the range of all frequency bins, and the average value is deemed to be the direction θ2 of the other sound source.

The beamformer process unit 5 executes a process of applying, to each of the SIMO signals separated and generated in the SIMO-ICA process unit 10, that is, to each of the first SIMO signal, constituted of the separated signals Y1^{(ICA1)} and Y2^{(ICA2)}, and the second SIMO signal, constituted of the separated signals Y2^{(ICA1)} and Y1^{(ICA2)}, a beamformer process of enhancing the sound components from the respective sound source directions θ1 and θ2, estimated by the sound source direction estimation unit 4, according to the respective frequency bins f (plurally sectioned frequency components) and outputting beamformer processed sound signals Y_{BF1}(f, t) to Y_{BF4}(f, t) (an example of a computer executing the beamformer process step). Here, the frequency bins f (frequency component sections) are sections with a uniform frequency width that has been set advance.

In the two beamformer process units 5 shown in FIG. 1, an indication “BF1θ1” denotes the enhancement of sound components from the sound source direction θ1 in the first SIMO signal (output of Y_{BF1}(f, t)), an indication “BF1θ2” denotes the enhancement of sound components from the sound source direction θ2 in the first SIMO signal (output of Y_{BF2}(f, t)), an indication “BF2θ1” denotes the enhancement of sound components from the sound source direction θ1 in the second SIMO signal (output of Y_{BF3}(f, t)), and an indication “BF2θ2” denotes the enhancement of sound components from the sound source direction θ2 in the second SIMO signal (output of Y_{BF4}(f, t)).

A beamformer process shall now be described in which, when the number of microphones is K, the number of sound sources is L, and K=L, the beamformer process unit 5 performs, on the basis of sound source directions (directions of arrival of sounds) θ₁ (with a subscript 1 denoting an integer from 1 to L) estimated (calculated) by the sound source direction estimation unit 4, enhancement of sounds from the respective sound source directions θ₁ by setting steering directions (beam directions) to the respective sound source directions θ₁.

As the beamformer process executed by the beamformer process unit 5, a known delay and sum beamformer process or a blind angle beamformer process can be considered. However, when using either type of beamformer process, arrangements are made so that a relatively high gain is obtained for a certain sound source direction θ₁ and relatively low gains are obtained for the other sound source directions.

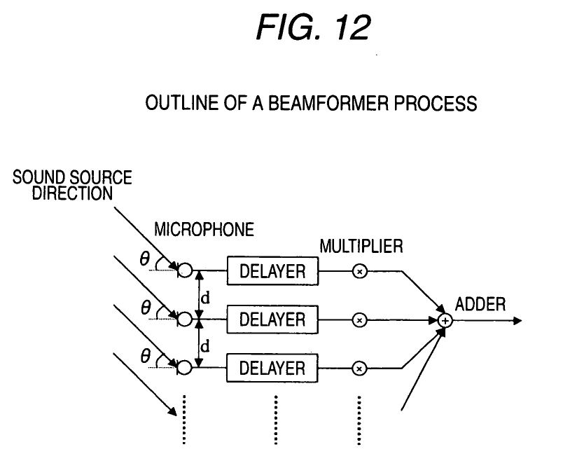

FIG. 12 is a conceptual diagram of the delay and sum beamformer process. Time deviations among sound signals arriving at respective microphones from a direction of θ are modified according to a distance d between the microphones and the direction θ by delayers, and a signal, with which sounds arriving from the specific direction θ are enhanced, is generated by multiplying each modified signal by a predetermined weighting factor and then adding the signals.

In the delay and sum beamformer process, a beamformer W_{BF1}(f) for a certain frequency bin f when the steering direction (beam direction) is set to θ1 (a beamformer that enhances sounds from the sound source direction θ1) can be determined by a following formula (12). In the formula (12), dₖ denotes a coordinate of a k-th microphone (d₁ to d_{K} in FIG. 11), c denotes the speed of sound, and j denotes a unit imaginary number.

### [Mathematical Formula 12]

W_{BF1}(f)=exp(−j2πfdₖ sin θ₁/c) (12)

The beamformer process unit 5 applies the beamformer based on the formula (12) to the respective SIMO signals to calculate the beamformer processed sound signals Y_{BF1}(f, t).

For example, when K=L=2, the beamformer process unit 5 performs calculation of a following formula (13) to compute the beamformer processed sound signals Y_{BF1}(f, t) to Y_{BF4}(f, t). Y_{BF1}(f, t) can be computed by similar formulae in cases even where K and L are 3 or more.

$$\begin{matrix}[ Mathematical Formula 13 ] & \\ [ \begin{matrix}{Y}_{BF 1} ( f , t ) & {Y}_{BF 3} ( f , t ) \\ {Y}_{BF 2} ( f , t ) & {Y}_{BF 4} ( f , t )\end{matrix} ] = [ \begin{matrix}{W}_{BF 1} ( f ) \\ {W}_{BF 2} ( f )\end{matrix} ] [ \begin{matrix}{Y}_{1}^{( ICA 1 )} ( f , t ) & {Y}_{1}^{( ICA 2 )} ( f , t ) \\ {Y}_{2}^{( ICA 2 )} ( f , t ) & {Y}_{2}^{( ICA 1 )} ( f , t )\end{matrix} ] & ( 13 )\end{matrix}$$

By executing the above-described beamformer process, sound signals Y_{BF1}(f, t), with which sounds from a targeted sound source direction θ1 are enhanced (strengthened relatively in signal strength), can be computed.

The intermediate process unit 6 performs a predetermined intermediate process, including performing a selection process or a synthesis process according to each frequency component bin on the beamformer processed sound signals other than a specific beamformer processed sound signal, among the beamformer processed sound signals (output signals of the beamformer process unit 5), with which the sound component from either of the sound source directions θ1 and θ2 (referred to herein after as the “specific sound source direction”) is enhanced for a certain SIMO signal (referred to herein after as “specific SIMO signal”), and outputting a signal obtained thereby (referred to herein after as the “intermediate processed signal”) (an example of a computer executing the intermediate process execution step).

Furthermore, one of the two intermediate process units 6 shown in FIG. 1 (a first intermediate process unit 6a) handles, from among the two SIMO signals, the SIMO signal constituted of the separated signals Y1^{(ICA1)} and Y2^{(ICA2)} as the specific SIMO signal, performs the intermediate process based on the three beamformer processed sound signals Ya2(f, t), Ya3(f, t), and Ya4(f, t) other than the specific beamformer processed sound signal Ya1(f, t), with which the sound component from the sound source direction θ1 is enhanced for the specific SIMO signal, and outputs a single intermediate processed signal Yb1(f, t). Moreover, the other intermediate process unit 6b handles, from among the two SIMO signals, the SIMO signal constituted of the separated signals Y2^{(ICA1)} and Y1^{(ICA2)} as the specific SIMO signal, performs the intermediate process based on the three beamformer processed sound signals Ya1(f, t), Ya2(f, t), and Ya3(f, t) other than the specific beam former processed sound signal Ya4(f, t), with which the sound component from the sound source direction θ2 is enhanced for the specific SIMO signal, and outputs a single intermediate processed signal Yb2(f, t).

With the example shown in FIG. 1, the first intermediate process unit 6a first performs, by means of a weighting correction process unit 61, correction (that is, correction by weighting) of the signal levels of the three beamformer processed sound signals YBF₂(f, t) to YBF₄(f, t) according to each frequency bin f (according to each frequency component resulting fromuniform sectioning by a predetermined frequency width) bymultiplying the signals (intensities) of the frequency bin f by predetermined weighting factors c1, c2, and c3. Furthermore, for each frequency bin f, the corrected signal of the maximum level is selected by a comparison object selection unit 62, and the selected signal is outputted as the first intermediate signal Y_{b1}(f, t). This intermediate process is expressed as: Max[c1·Y_{BF2}(f, t), c2·Y_{BF3}(f, t), c3·Y_{BF4}(f, t)].

Moreover, the second intermediate process unit 6b first performs, by means of a weighting correction process unit 61, correction (that is, correction by weighting) of the signal levels of the three beamformer processed sound signals YBF₁(f, t) to YBF₃(f, t) according to each frequency bin f by multiplying the signals (intensities) of the frequency bin f by the predetermined weighting factors c3, c2, and c1. Furthermore, for each frequency bin f, the corrected signal of the maximum level is selected by a comparison object selection unit 62, and the selected signal is outputted as the second intermediate signal Y_{b2}(f, t). This intermediate process is expressed as: Max [c3*Y_{BF1}(f, t), c2·Y_{BF2}(f, t), c3·Y_{BF3}(f, t)].

Here, c1 to c3 are weighting factors of no less than 0 and less than 1, and is set, for example, so that 1≧c1>c3>c2≧0, etc., For example the weighting factors are set so that c1=1, c2=0, and c3=0.7.

The untargeted signal component elimination unit 7 executes a process of comparing, for one signal in the specific SIMO signal (the first SIMO signal or the second SIMO signal), volumes of the specific beamformer processed sound signal and the intermediate processed signal according to each frequency bin (according to each of the plurally sectioned frequency components) and, when a comparison result meets predetermined conditions, of eliminating the signal of the corresponding frequency component and performs a process of generating, and outputting the signal obtained thereby as the separated signal corresponding to the sound source signal (an example of the computer executing the untargeted signal component elimination step).

With the example shown in FIG. 1, in one of the two untargeted signal component elimination units 7 (a first untargeted signal component elimination unit 7a), a comparison unit 71 compares, for Y1^{(ICA1)}(f, t), which is one signal in the first SIMO signal (an example of the specific SIMO signal), magnitudes of signal levels of the sound signal Y_{BF1}(f, t) after application of the beamformer process to the first SIMO signal and the first intermediate processed signal Y_{b1}(f, t), outputted from the first intermediate process unit 6a, according to each frequency bin f. If the comparison result meets the condition: Y_{BF1}(f, t)>Y_{b1}(f, t), a signal elimination unit 72 in the first untargeted signal component elimination unit 7a eliminates the signal of the frequency bin f from the signal Y1^{(ICA1)}(f, t) and outputs the signal obtained thereby.

Furthermore, in the other of the two untargeted signal component elimination units 7 (a second untargeted signal component elimination unit 7b), a comparison unit 71 compares, for Y2^{(ICA1)}(f, t), which is one signal in the second SIMO signal (an example of the specific SIMO signal), magnitudes of signal levels of the sound signal Y_{BF4}(f, t) after application of the beamformer process to the second SIMO signal, and the second intermediate processed signal Y_{b2}(f, t), outputted from the second intermediate process unit 6b according to each frequency bin f. If the comparison result meets the condition: Y_{BF4}(f, t)>Y_{b2}(f, t), a signal elimination unit 72 in the second untargeted signal component elimination unit 7b eliminates the signal of the frequency bin f from the signal Y2^{(ICA1)}(f, t) and outputs the signal obtained thereby.

For example, in the first untargeted signal component elimination unit 7a, the comparison unit 71 outputs, for each frequency bin f, “1” as the comparison result m₁(f, t) if Y_{BF1}(f, t)>Y_{b1}(f, t) and “0” as the comparison result m₁(f, t) if not, and the signal elimination unit 72 multiplies the signal Y1^{(ICA1)}(f, t) by m₁(f, t). The same process is also performed in the second untargeted signal component elimination unit 7b.

A following formula (14) expresses the process executed by the first intermediate process unit 6a and the comparison unit 71 in the first untargeted signal component elimination unit 7a:

### [Mathematical Formula 14]

Y_{BF1}(f,t)>max[c₁|Y_{BF2}(f,t)|,c₂|Y_{BF3}(f,t)|,c₃|Y_{BF4}(f,t)|] (14)

m₁(f, t)=1 if the above formula is satisfied and m₁(f, t)=0 if not.

A following formula (15) expresses the process executed by the signal elimination unit 72 in the first untargeted signal component elimination unit 7a. The left side of the formula (15) expresses the signal that is generated and outputted as the separated signal corresponding to the sound source signal.

### [Mathematical Formula 15]

\hat{Y}₁(f,t)=m₁(f,t)Y₁^{(ICA1)}(f,t) (15)

Actions and effects of the sound source separation apparatus X1 shall now be described.

The separated signals Y1^{(ICA1)}(f, t), Y2^{(ICA2)}(f, t) Y2^{(ICA1)}(f, t), and Y1^{(ICA2)}(f, t), outputted by the SIMO-ICA process unit 10 that performs the sound source separation process that makes note of the independence of each of the plurality of sound source signals as described above, possibly contain components of sound signals (noise signals) from sound sources (non-targeted sound sources) other than the specific sound sources to be noted (targeted sound sources). Thus in a case where, in the separated signal Y1^{(ICA1)}(f, t) that should correspond to the specific sound source signal S1(t), there are present signals of the same frequency components as the frequency components of high signal level (volume) in the separated signals Y2^{(ICA1)}(f, t) and Y1^{(ICA2)}(f, t), corresponding to the other sound source signal S2(t), by eliminating the signals of these frequency components by the same process as that of the binaural signal process, the noise signals that became mixed from the sound source other than the specific sound source can be eliminated. Thus for example in the sound source separation apparatus X1, shown in FIG. 1, by eliminating, from the separated signal Y1^{(ICA1)}(f, t), corresponding to the specific sound source, the frequency components that are low in signal level in comparison to the separated signals Y2^{(ICA1)}(f, t) and Y1^{(ICA2)}(f, t), necessarily corresponding to the specific sound source, by means of the first untargeted signal component elimination unit 7a, the interfusion of noise can be suppressed and the sound source separation process performance can be heightened.

However, because the untargeted signal component elimination unit 7 makes the judgment of a noise signal based on volume (signal level), when there is a bias in the positions of the sound sources with respect to the plurality of microphones, the signals from the specific sound source to be noted (targeted sound source) cannot be distinguished from signals (noise signals) from the other sound sources (non-targeted sound sources).

Meanwhile, in the sound source separation apparatus X1, the beamformer process of enhancing the sounds from each of the sound source directions θ1 and θ2 is applied to the respective SIMO signals by the beamformer process unit 5, and the process by the untargeted signal component elimination unit 7 is executed on signals based on the beamformer processed sound signals Y_{BF1}(f, t) to Y_{BF4}(f, t). Here, the spectrum of the beam former processed sound signals Y_{BF1}(f, t) to Y_{BF4}(f, t) approximates the spectrum of sound signals obtained through directional microphones with the steering directions being set at the directions in which the respective sound sources are present. Thus even if there is a bias in the positions of the sound sources with respect to the plurality of microphones, the signals inputted into the untargeted signal component elimination unit 7 are signals with which the effects of the bias of the sound source positions are eliminated. Thus when, as in the sound source separation apparatus X1, the beamformer processed signal Y_{BF1}(f, t) corresponding to the specific sound source signal S1(t) contains signals of the same frequency components as the frequency components of high signal level (volume) in the beamformer processed signals Y_{BF2}(f, t) and Y_{BF3}(f, t), corresponding to the other sound source signal S2(t), by eliminating the signals of these frequency components from the separated signal Y1^{(ICA1)}(f, t) by means of the untargeted signal component elimination unit 7, the noise signals that became mixed from the sound source other than the specific sound source can be eliminated even if there is a bias in the positions of the sound sources with respect to the plurality of microphones.

Also, Other beamformer processed sound signals (for example, Y_{BF2}(f, t) to Y_{BF4}(f, t)) corresponding to the sound source (non-targeted sound source) other than the specific sound source to be noted (targeted sound source), the untargeted signal component elimination unit 7 in the sound source separation apparatus X1 subjects not the signals themselves but the signal (for example, Y_{b1}(f, t)) after application of the intermediate process to the signals to the comparison with the beamformer processed sound signal (for example, Y_{BF1}(f, t)) corresponding to the specific sound source. A high sound source separation process performance can thus be maintained even if the acoustic environment changes.

Normally, Y_{BF1}(f, t) is the corresponding beamformer processed sound signal that expresses the sound signal S1(t) the best, and Y_{BF4}(f, t) is the beamformer processed sound signal corresponding to the sound source signal S2(t).

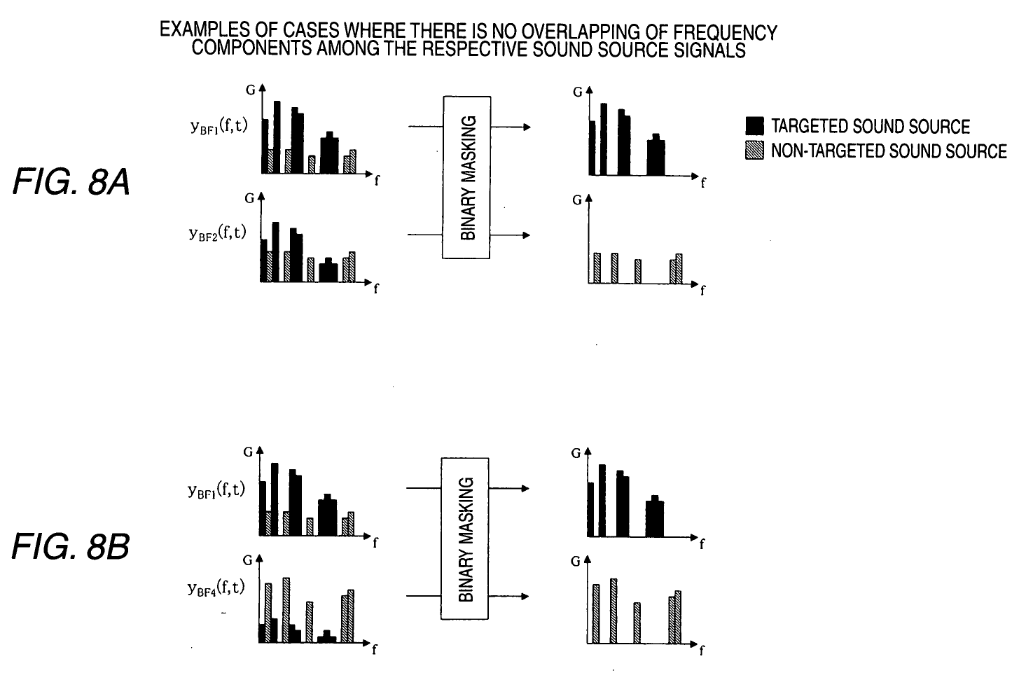

A relationship between combinations of input signals into a binary masking process and the separation performance and sound qualities of the separated signals in a case where the binary masking process is executed on the beamformer processed sound signals shall now be described with reference to FIGS. 8A to 10B. In the following description, a process of eliminating the signal components corresponding to the non-targeted sound source from the beamformer processed sound signal Y_{b1}(f, t) corresponding to the targeted sound source by the binary masking process can be regarded to be equivalent to the process of eliminating the signal components corresponding to the non-targeted sound source from the separated signal Y1^{(ICA1)}(f, t) corresponding to the targeted sound source in the specific SIMO signal by means of the untargeted signal component elimination unit 7.

Each of FIGS. 8A to 10B shows schematic diagrams of examples (first to third examples) of signal level (amplitude) distributions according to the frequency component of signals before and after applying the binary masking process to beamformer processed sound signals. Whereas, in a case where the targeted sound source signal to be noted is S1(t), although in regard to the four beamformer processed sound signals Y_{BF1}(f, t) to Y_{BF4}(f, t), three patterns of combinations of two signals that include the sound signal Y_{BF1}(f, t) corresponding to the targeted sound signal S1(t) can be considered, Y_{BF1}(f, t) and Y_{BF3}(f, t) have similar spectra to begin with. FIGS. 8A to 10B thus show examples of performing the binary masking process on each of the combination of Y_{BF1}(f, t) and Y_{BF2}(f, t) and the combination of Y_{BF1}(f, t) and Y_{BF4}(f, t).

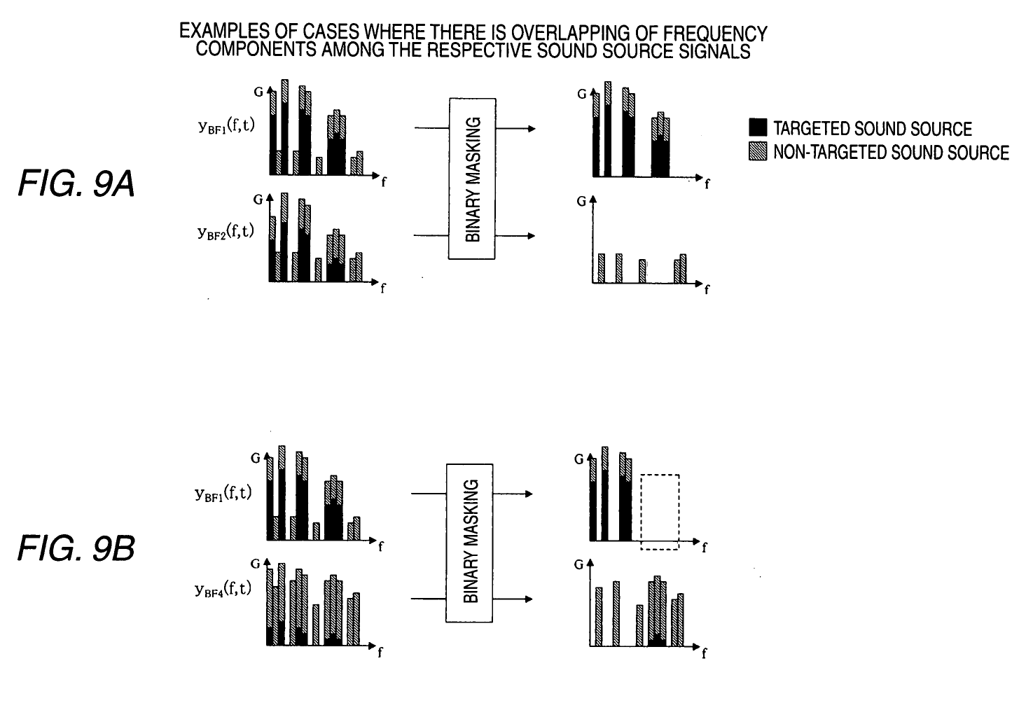

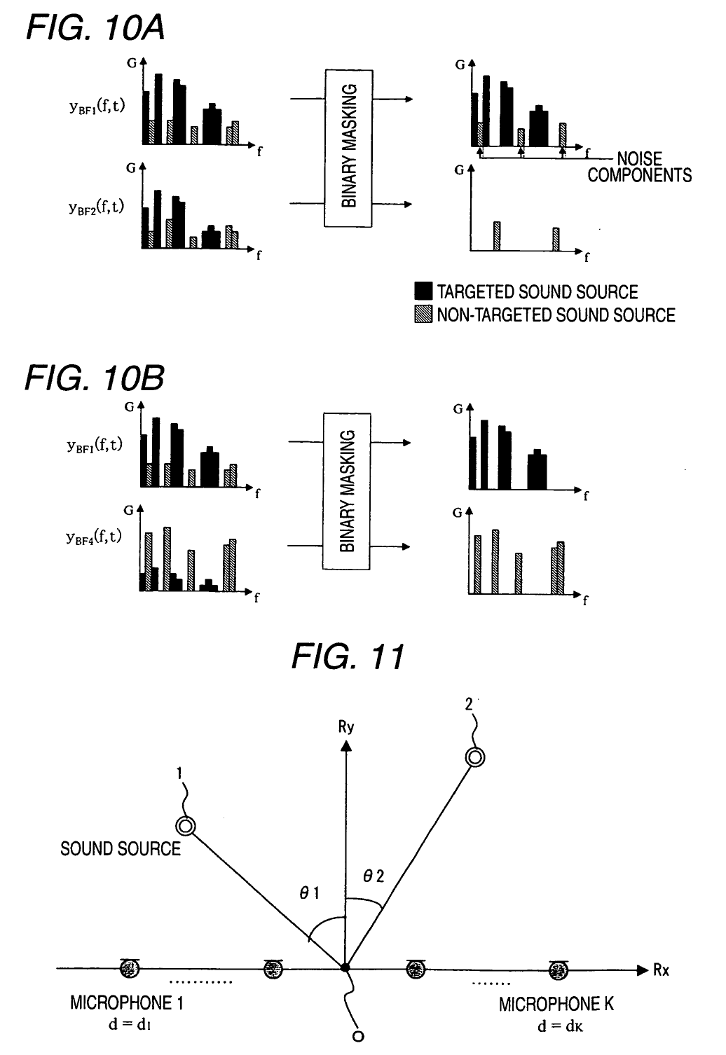

FIGS. 8A and 8B show examples of cases where there is no overlapping of frequency components among the respective sound source signals, and FIGS. 9A and 9B show examples of cases where there is overlapping of frequency components among the respective sound source signals. Whereas, FIGS. 10A and 10B show examples of cases where there is no overlapping of frequency components among the respective sound source signals and the signal level of the targeted sound source signal S1(t) is relatively low (the amplitude is low) with respect to the signal level of the non-targeted sound source signal S2(t).

Furthermore, FIGS. 8A, 9A, and 10A show examples of cases where the input signals into a binaural signal process are the combination of the signal Y_{BF1}(f, t) and the signal Y_{BF2}(f, t).

Meanwhile, FIGS. 8B, 9B, and 10B show examples of cases where the signals inputted into the binaural signal process are the combination of the signal Y_{BF1}(f, t) and the signal Y_{BF4}(f, t).

As shown in FIGS. 8A and 9B, although in the signals inputted into the binaural signal process, components of the sound source signal to be subj ect to identification are dominant, components of the other sound source signal are also mixed in slightly as noise.

When the binary masking process is applied to such inputted signals that contain noise, if there is no overlap of frequency components among the sound source signals as shown in the output signal level distributions (the bar graphs at the right side) of FIGS. 8A and 8B, separated signals of good quality that correspond to the respective sound source signals are obtained regardless of the inputted signal combination.

In such a case where there is no overlap of frequency components among the respective sound source signals, in the respective signals inputted into the binaural signal process, the signal levels of the frequency components of the sound source signal to be identified are high, the signal levels of the frequency components of the other sound source signal are low, and thus level differences are clear and the signals can be reliably separated by the binary masking process performing signal separation according to the signal level of each frequency component. A high separation performance is thus obtained regardless of the combination of the inputted signals.

However, generally in an actual acoustic space (sound environment), a situation, where there is absolutely no overlap of frequency components (frequency bands) between the targeted sound source signal to be identified and the other non-targeted sound source signals, hardly occurs, and there are overlaps of frequency components, even if slightly, among the plurality of sound source signals. Here, even if there is overlapping of frequency components between the respective sound source signals, with the “pattern a,” even though noise signals (components of the sound source signal other than the signal to be identified) remain slightly for the frequency components that overlap between the sound source signals, the noise signals are reliably separated for the other frequency components as shown in the output signal level distributions (bar graphs at the right side) of FIG. 9A.

With the “pattern a” shown in FIG. 9A, the signal levels of the signals inputted into the binaural signal process have level differences in accordance with the distances from the sound source to be identified to the microphones. Thus in the binary masking process, the signals can be reliably separated due to the level differences. This is considered to be a reason why a high separation performance is obtained with the “pattern a”, even though there is overlapping of frequency components between the respective sound source signals.

Meanwhile, with the “pattern b,” when there is overlapping of frequency components between the respective sound source signals, an inconvenient phenomenon that signal components that properly should be outputted (signal components of the sound source signal to be identified) become lost for the frequency components that overlap between the respective sound source signals occurs as shown in FIG. 9B (the portion surrounded by broken lines in FIG. 9B).

Such a loss occurs due to the input level of the non-targeted sound source signal S2(t) into the microphone 112 being higher than the input level of the targeted sound source signal S1(t) into the microphone 112. The sound quality degrades when there is such a loss.

It can thus be said that in general, good separation performance can be obtained in many cases when the “pattern a” is employed.

However, in an actual acoustic environment, the signal levels of the respective sound source signals vary, and depending on the circumstances, the signal level of the targeted sound source signal S1(t) becomes lower relative to the signal level of the untargeted sound source signal S2(t) as shown in FIG. 10.

In such case, as a result of adequate sound source separation process not being performed at the SIMO-ICA process unit, components of the non-targeted sound source signal S2(t) that remain in the beamformer processed sound signals Y_{BF1}(f, t) and Y_{BF2}(f, t) become relatively large. Thus when the “pattern a” shown in FIG. 10A is employed, an inconvenient phenomenon that components of the non-targeted sound source signal S1(t) (noise components) remain in the separated signal outputted as corresponding to the targeted soundsourcesignalSl (t) occurs as indicated by arrows in FIG. 10A. The sound source separation process performance degrades when this phenomenon occurs.

Meanwhile, when the “pattern b” shown in FIG. 10B is employed, although the results depend on the signal levels, there is a high possibility that the remaining of noise components, such as indicated by the arrows in FIG. 10A, can be avoided.

Thus in the first intermediate process unit 6a, by performing volume correction of the signal Y_{BF4}(f, t) by a weighting factor less than that of the signal Y_{BF2}(f, t) (c1>c3), selecting the signal of higher volume (signal level) among the signal obtained by correcting the signal Y_{BF2}(f, t) and the signal obtained by correcting the signal Y_{BF4}(f, t), and performing the elimination of noise signal components by means of the first untargeted signal component elimination unit 7a based on the selected signal, it becomes possible to maintain a high sound source separation process performance even when the acoustic environment changes.

Experimental results of sound source separation process performance evaluation using the sound source separation apparatus X1 shall now be described.

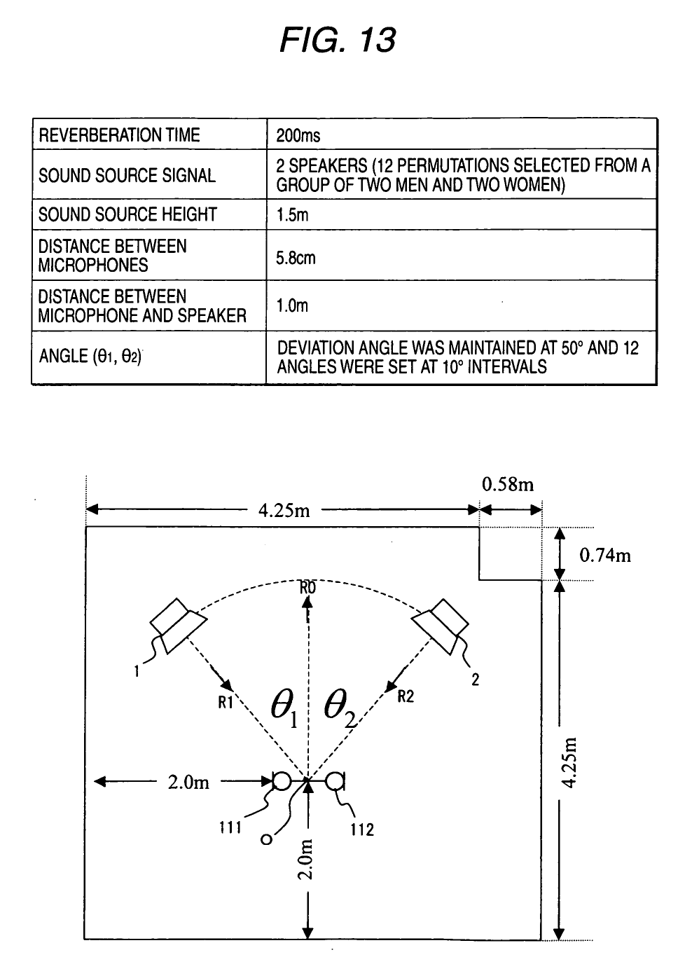

FIG. 13 is a diagram for describing experimental conditions of the sound source separation process performance evaluation using the sound source separation apparatus X1.

As shown in FIG. 13, with the experimental conditions of the sound source separation process performance evaluation experiment, two speakers, present at two predetermined locations inside a living room of a size shown in FIG. 13, are the sound sources, sound signals (voices of the speakers) from the respective sound sources (speakers) are inputted by two microphones facing opposite directions with respect to each other, and the performance of separating the respective sound signals (sound source signals) of the speakers from the mixed sound signals of two channels that are inputted is evaluated. Here, the experiment was performed for 12 types of conditions corresponding to permutations of two persons selected from among two men and two women (total of four persons) as the speakers to be the sound sources (even in cases where the same two speakers are the sound sources, conditions were deemed to be different if the positioning of the two persons are switched), and the sound source separation process performance was evaluated using an average value of evaluation values obtained for each combination.

With all experimental conditions, a reverberation time was 200 ms, the distance from a sound source (speaker) to the nearest microphone was set to 1.0 m, and the microphones 111 and 112 were positioned apart at an interval of 5.8 cm.

Here, when a reference direction R0 (corresponding to the direction Ry in FIG. 11) is a direction, which, when viewed from above, is perpendicular to the directions of the microphones 111 and 112, directed in mutually opposite directions, θ1 is an angle formed by the reference direction R0 and a direction R1 directed from one sound source S1 (speaker) to a midpoint O of the microphones 111 and 112. θ2 is an angle formed by the reference direction R0 and a direction R2 directed from the other sound source S2 (speaker) to the midpoint O. Here, combinations of θ1 and θ2 were set (equipment were positioned) so as to provide 12 patterns of conditions with a deviation angle being maintained at 50° and both θ1 and θ2 being varied by 10° at a time, that is, (θ1, θ2)=(−80°, −30°), (−70°, −20°), (−60°, −10°), (−50°, 0°), (−40°, +10°), (−30°, +20°), (−20°, +30°), (−10°, +40°), (0°, +50°), (+10°, +60°), (+20°, +70°), and (+30°, +80°), and the experiment was performed under the respective conditions.

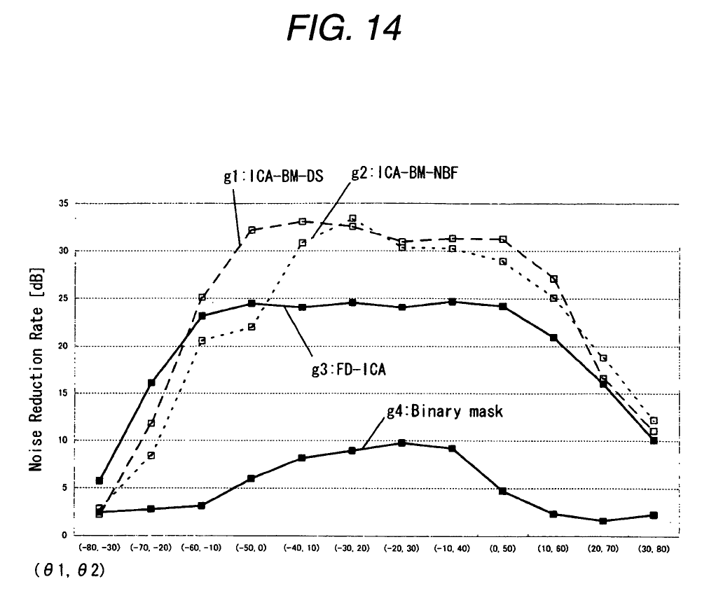

FIG. 14 is a graph of sound source separation process performance evaluation results of sound source separation process performed by each of a related sound source separation apparatus and a sound source separation apparatus according to the present invention under the above-described experimental conditions.

Here, as an evaluation value (ordinate of the graph) of the sound source separation process performance shown in FIG. 14, NRR (noise reduction rate) was used. The NRR is an index that expresses a degree of noise removal and a unit thereof is (dB). It can be said that the higher the NRR value, the higher the sound source separation process performance.

Graph lines g1 to g4 in the graph shown in FIG. 14 express the processing results in the following cases.

The graph line g1 (ICA-BM-DS) expresses results of processing by the sound source separation apparatus X1 in a case where the delay and sum beamformer process is performed in the beamformer process unit 5. The weighting factors are: (c1, c2, c3)=(1, 0, 0.7). The graph line g2 (ICA-BM-NBF) expresses results of processing by the sound source separation apparatus X1 in a case where the subtraction beamformer process is performed in the beamformer process unit 5. The weighting factors are: (c1, c2, c3)=(1, 0, 0.7).

The graph line g3 (ICA-BM-DS) expresses results of processing by the SIMO-ICA process unit 10 in the sound source separation apparatus X1.

The graph line g4 (Binary mask) expresses results of the binary masking process.

From the graph shown in FIG. 14, it can be understood that the sound source separation process (g1, g2) according to the present invention is higher in NRR value and better in soundsource separation processperformance thanwhen thebinary masking process is performed alone (g4).

It can also be understood that, with the exception of a portion of the conditions, the sound source separation process (g1, g2) according to the present invention is generally higher in NRR value and better in sound source separation process performance than when the BSS method sound source separation process based on the ICA method is performed alone (g3).

As described above, with the sound source separation apparatus X1, by simply adjusting the parameters (the weighting factors c1 to c3) used in the intermediate process in the intermediate process unit 6, a high sound source separation process performance can be maintained even if the acoustic environment changes.

Thus if the sound source separation apparatus X1 has adjustment knobs, numerical input operation keys, or other operation input units (example of an intermediate process parameter setting means) and the intermediate process unit 6 has a function of setting (adjusting) the parameters (here, the weighting factors c1 to c3) used in the intermediate process in accordance with information inputted through the operation input units, a high sound source separation process performance can be maintained even if the acoustic environment changes.

### Second Embodiment

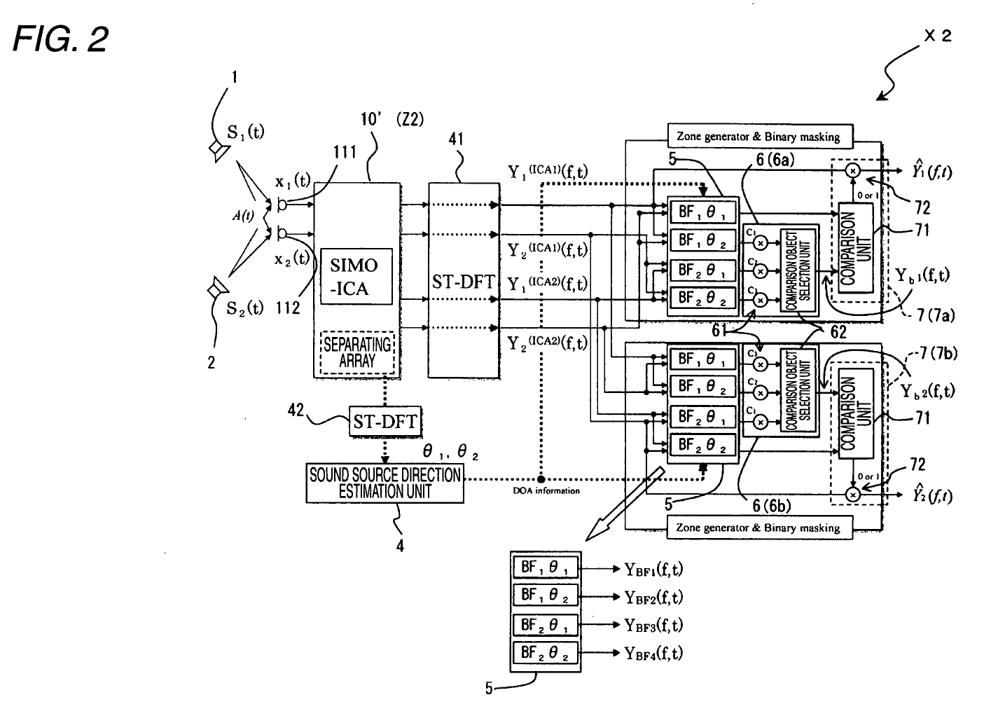

### See FIG. 2

A sound source separation apparatus X2 according to a second embodiment of the present invention shall nowbe described with reference to a block diagram shown in FIG. 2.

The sound source separation apparatus X2 has basically the same arrangement as the sound source separation apparatus X1, and only the points of difference with respect to the sound source separation apparatus X1 shall be described below. In FIG. 2, components that are the same as those of FIG. 1 are provided with the same symbols.

With the sound source separation apparatus X2, the SIMO-ICA process unit 10 (employing the sound source separation apparatus Z4 or Z5 that performs the SIMO-ICA process in the frequency domain) in the sound source separation apparatus X1 is replaced by an SIMO-ICA process unit 10′ employing the sound source separation apparatus Z2 that performs the sound source separation process based on the TD-SIMO-ICA method (SIMO-ICA process in the time domain).

The separated signal obtained by the SIMO-ICA process unit 10′ employing the sound source separation apparatus Z2 is a signal in the time domain. The separating matrix W(t), obtained by the SIMO-ICA process unit 10′ employing the sound source separation apparatus Z2, is also a separating matrix of the time domain.

The sound source separation apparatus X2 thus has a first shorttimediscreteFouriertransformprocessunit 41 (expressed as “ST-DFT” in the figure) that converts the time domain separated signals, outputted by the SIMO-ICA process unit 10′, to the frequency domain separated signals Y1^{(ICA2)}(f, t), Y2^{(ICA2)}(f, t), Y1^{(ICA2)}(f, t), and Y2^{(ICA1)}(f, t). The separated signals Y1^{(ICA1)}(f, t), Y2^{(ICA2)}(f, t), Y1^{(ICA2)}(f, t), and Y2^{(ICA1)}(f, t) outputted from the first short time discrete Fourier transform process unit 41 are inputted into the beamformer process unit 5.

The sound source separation apparatus X2 furthermore has a second short time discrete Fourier transform process unit 42 (expressed as “ST-DFT” in the figure) that converts the time domain separating matrix W(t), obtained by learning calculation at the SIMO-ICA process unit 10′ into the frequency domain separating matrix W(f). The separating matrix W(f), outputted from the second short time discrete Fourier transform process unit 42 is inputted into sound source direction estimation unit 4. Besides the points of difference described above, the sound source separation apparatus X2 has the same arrangement as the sound source separation apparatus X1.

Such a sound source separation apparatus X2 exhibits the same actions and effects as the sound source separation apparatus X1.

Although with the above embodiments, examples where the number of channels is two (the number of microphones is two) as shown in FIG. 1 or 2 were described, as long as (the number n of channels of the inputted mixed sound signals (that is, the number of microphones))≧ (number of sound sources m), the present invention can be put into practice by the same arrangements even when there are three or more channels.

Also, with the above embodiments, an example of performing the intermediate process of: Max[c1·Y_{BF2}(f, t), c2·Y_{BF3}(f, t), c3·Y_{BF4}(f, t)] or Max[c3·Y_{BF1}(f, t), c2·Y_{BF2}(f, t), c3·Y_{BF4}(f, t)] by the intermediate process unit 6 was described.

However, the intermediate process is not limited thereto.

As the intermediate process executed by the intermediate process unit 6, the following examples can also be considered.

That is, first, the first intermediate process unit 6a performs correction (that is, correction by weighting) of the signal levels of the three beamformer processed sound signals Y_{BF2}(f, t), Y_{BF3}(f, t), and Y_{BF4}(f, t) according to each frequency bin f (according to each frequency component resulting from uniform sectioning by a predetermined frequency width) by multiplying predetermined weighting factors a1, a2, and a3 to signals of the frequency bin f. Furthermore, for each frequency bin f, the corrected signals are synthesized. That is, an intermediate process of: a1·Y_{BF2}(f, t)+a2·Y_{BF3}(f, t)+a3·Y_{BF4}(f, t) is performed.

The first intermediate process unit 6a furthermore outputs the intermediate processed signal (in which are synthesized the signals that have been subject to correction by weighting according to each frequency component) obtained by the intermediate process to the first untargeted signal component elimination unit 7a.

The same applies to the second intermediate process unit 6b as well.

Even when such an intermediate process is employed, the same actions and effects as the above-described embodiments are obtained. Obviously, the intermediate process is not limited to these two types of intermediate process and employment of other intermediate processes may be considered. An arrangement, in which the number of channels is expanded to three or more channels, may also be considered.

According to an aspect of the present invention, by performing the two-stage processes of the sound source separation process (the SIMO-ICA process) of the blind source separation method based on the independent component analysis method and the low-volume signal component elimination signal process based on volume comparison (the untargeted signal component elimination process), equivalent to the binary masking process, a high sound source separation process performance can be obtained.

Furthermore, according to an aspect of the present invention, regarding the SIMO signal obtained by the sound source separation process (the SIMO-ICA process) of the blind source separation method based on the independent component analysis method, the beamformer process performing sound enhancement according to sound source direction and the untargeted signal component elimination process following the intermediate process according topurpose are executed. A high soundsource separation process performance can thereby be obtained even under an environment where bias in the positions of the sound sources with respect to the plurality of sound input means (microphones) can occur. For example, in accordance with the contents of the intermediate process, a sound source separation process, by which the sound source separation process performance is heightened in particular, or a sound source separation process, in which the sound quality of the sound signal after separation is heightened in particular, can be realized. Also, by performing as the SIMO-ICA process, the sound source separation process of the blind source separation method based on the frequency domain SIMO independent component analysis method or the sound source separation process of the blind source separation method based on a combination of a method of the frequency domain independent component analysis method and the projection back method, the processing load can be remarkably lightened in comparison to the blind source separation method based on the time domain SIMO independent component analysis method.

What is claimed is:

1. A sound source separation apparatus, comprising:
a plurality of sound input means, into which a plurality of mixed sound signals in which sound source signals from a plurality of sound sources are superimposed are inputted;
an SIMO-ICA process means, separating and generating SIMO signals each of which corresponds to at least one of the sound source signals from the plurality of mixed sound signals by a sound source separation process of a blind source separation method based on an independent component analysis method;
a sound source direction estimation means, estimating sound source directions which are directions in which the sound sources are present, respectively, based on a separating matrix calculated by a learning calculation executed in the sound source separation process of the blind source separation method based on the independent component analysis method in the SIMO-ICA process means;
a beamformer process means,
applying, to each of the SIMO signals separated and generated in the SIMO-ICA process means, a beamformer process of enhancing, according to each of plurally sectioned frequency components, a sound component from each of the sound source directions estimated by the sound source estimation means, and
outputting beamformer processed sound signals; an intermediate process execution means,
performing a predetermined intermediate process including a selection process or a synthesis process, according to each of the plurally sectioned frequency components, on the beamformer processed sound signals other than a specific beamformer processed sound signal with which a sound component from a specific sound source direction which is one of the sound source directions is enhanced for a specific SIMO-signal which is one of the SIMO signals, and
outputting an intermediate processed signal obtained thereby; and
an untargeted signal component elimination means,
performing, on one signal in the specific SIMO signal, a process of comparing volumes of the specific beamformer processed sound signal and the intermediate processed signal according to each of the plurally sectioned frequency components and, when a comparison result meets a predetermined condition, of eliminating a signal of the corresponding frequency component, and
generating a signal obtained thereby as a separated signal corresponding to one of the sound source signals.

2. The sound source separation apparatus according to claim 1, wherein the sound source separation process of the blind source separation method based on the independent component analysis method in the SIMO-ICA process means includes a sound source separation process of a blind source separation method based on a frequency domain SIMO independent component analysis method, and
wherein the SIMO-ICA process means comprises:
a short time discrete Fourier transform means, applying a short time discrete Fourier transform process to the plurality of mixed sound signals in a time domain, and converting the mixed sound signals into a plurality of mixed sound signals in a frequency domain;
an FDICA sound source separation process means, applying a separation process based on a predetermined separating matrix on the plurality of mixed sound signals in the frequency domain to generate first separated signals each of which corresponds to one of the sound source signals, according to each mixed sound signal;
a subtraction means, generating second separated signals by subtracting, from each of the plurality of mixed sound signals in the frequency domain, the first separated signals generated by the FDICA sound source separation process means based on the corresponding mixed sound signal; and
a separating matrix calculation means, calculating the separating matrix in the FDICA sound source separation process means by a successive calculation based on the first separated signals and the second separated signals.

3. The sound source separation apparatus according to claim 1, wherein
the sound source separation process of the blind source separation method based on the independent component analysis method in the SIMO-ICA process means includes a sound source separation process of a blind source separation method based on a combination of a frequency domain independent component analysis method and a projection back method.

4. The sound source separation apparatus according to claim 1, wherein
the beamformer process performed by the beamformer process means includes a delay and sum beamformer process or a blind angle beamformer process.

5. The sound source separation apparatus according to claim 1, wherein
the intermediate process execution means corrects the beamformer processed sound signals by a predetermined weighting of signal levels according to the plurally sectioned frequency components, and performs the selection process or the synthesis process on the corrected signals according to each frequency component.

6. The sound source separation apparatus according to claim 5, wherein
the intermediate process execution means performs a process of selecting, from among the corrected signals, a signal having the highest signal level according to each frequency component.

7. The sound source separation apparatus according to claim 1, further comprising:
an intermediate process parameter setting means, setting, in accordance with a predetermined operation input, a parameter used in the intermediate process in the intermediate process setting means.

8. A sound source separation method comprising:
a plurality of sound input steps of inputting a plurality of mixed sound signals in which sound source signals from a plurality of sound sources are superimposed;
an SIMO-ICA process step of separating and generating SIMO signals each of which corresponds to at least one of the sound source signals from the plurality of mixed sound signals by a sound source separation process of a blind source separation method based on an independent component analysis method;
a sound source direction estimating step of estimating sound source directions which are directions in which the sound sources are present, respectively, based on a separating matrix calculated by a learning calculation executed in the sound source separation process of the blind source separation method based on the independent component analysis method in the SIMO-ICA process step;
a beamformer process step of
applying, to each of the SIMO signals separated and generated in the SIMO-ICA process step, a beamformer process of enhancing, according to each of plurally sectioned frequency components, a sound component from each of the sound source directions estimated by the sound source estimation step, and
outputting beamformer processed sound signals;
an intermediate process execution step of
performing a predetermined intermediate process including a selection process or a synthesis process, according to each of the plurally sectioned frequency components, on the beamformer processed sound signals other than a specific beamformer processed sound signal with which a sound component from a specific sound source direction, which is one of the sound source directions is enhanced for a specific SIMO signal which is one of the SIMO signals, and
outputting an intermediate processed signal obtained thereby; and
an untargeted signal component elimination step of
performing, on one signal in the specific SIMO signal, a process of comparing volumes of the specific beamformer processed sound signal and the intermediate processed signal according to each of the plurally sectioned frequency components and, when a comparison result meets a predetermined condition, of eliminating a signal of the corresponding frequency component, and
generating a signal obtained thereby as a separated signal corresponding to one of the sound source signals.

9. The sound source separation method according to claim 8, wherein the sound source separation process of the blind source separation method based on the independent component analysis method in the SIMO-ICA process step includes a sound source separation process of a blind source separation method based on a frequency domain SIMO independent component analysis method and
wherein the SIMO-ICA process step comprises:
a short time discrete Fourier transform step of applying a short time discrete Fourier transform process to the plurality of mixed sound signals in a time domain, and converting the mixed sound signals into a plurality of mixed sound signals in a frequency domain;
an FDICA sound source separation process step of applying a separation process based on a predetermined separating matrix on the plurality of mixed sound signals in the frequency domain to generate first separated signals each of which corresponds to one of the sound source signals, according to each mixed sound signal;
a subtraction step of generating second separated signals by subtracting, from each of the plurality of mixed sound signals in the frequency domain, the first separated signals generated by the FDICA sound source separation process step based on the corresponding mixed sound signal; and
a separating matrix calculation step of calculating the separating matrix in the FDICA sound source separation process step by a successive calculation based on the first separated signals and the second separated signals.

10. The sound source separation method according to claim 8, wherein
the sound source separation process of the blind source separation method based on the independent component analysis method in the SIMO-ICA process step includes a sound source separation process of a blind source separation method based on a combination of a frequency domain independent component analysis method and a projection back method.

11. The sound source separation method according to claim 8, wherein
the beamformer process performed in the beamformer process step includes a delay and sum beamformer process or a blind angle beamformer process.

12. The sound source separation method according to claim 8, wherein
in the intermediate process execution step, the beamformer processed sound signals are corrected by a predetermined weighting of signal levels according to the plurally sectioned frequency components, and the selection process or the synthesis process is performed on the corrected signals according to each frequency component.

13. The sound source separation method according to claim 12, wherein
in the intermediate process execution step, a process of selecting, from among the corrected signals, a signal of the highest signal level according to each frequency component, is performed.

14. The sound source separation method according to claim 8, further comprising:
an intermediate process parameter setting step of setting, in accordance with a predetermined operation input, a parameter used in the intermediate process in the intermediate process setting step.
